(19) United States
(12) Patent Application Publication
(10) Pub. No.: US 2010/0138181 A1
(43) Pub. Date: Jun. 3, 2010

(54) TESTING APPARATUS

(75) Inventor: Mitsugu Nagoya, Tokyo (JP)

Correspondence Address: LADAS & PARRY, 5670 WILSHIRE BOULEVARD, SUITE 2100, LOS ANGELES, CA, 90036-5679, US

(73) Assignee: DUAXES CORPORATION, Tokyo (JP)

(21) Appl. No.: 12/516,576

(22) PCT Filed: Nov. 29, 2006
(86) PCT No.: PCT/JP2006/323847

§ 371 Date: Feb. 8, 2010

(51) Int. Cl. G06F 19/00; G06F 7/00

(52) U.S. Cl. 702/108; 707/758

(57) ABSTRACT

A testing apparatus tests a communication control apparatus, which performs given processing on input communication data and outputs the data. The testing apparatus includes an output unit which outputs data to the communication control apparatus, a generating unit which generates data to be output by the communication control apparatus after the apparatus normally processes data output to the apparatus, an input unit which inputs data output by the communication control apparatus, and an inspection unit which compares data generated by the generating unit with data input by the input unit to check if the communication control apparatus operates normally.

### TECHNICAL FIELD

The present invention relates to a testing apparatus for testing a communication control apparatus.

### BACKGROUND ART

Due to improved Internet infrastructures and the widespread of communication terminals, such as cellular phone terminals, personal computers, and VoIP (Voice over Internet Protocol) phone sets, the number of Internet users is now exploding. Under such circumstances, security problems such as computer viruses, hacking and spam mails have become apparent, requiring appropriate techniques for communication control.

In order to achieve appropriate communication control, communication control apparatuses for performing packet filtering, etc. have been developed and have come into practical use. However, although there is provided an environment for transmitting a large amount of data at high speed thanks to improved infrastructures including optical cables, such infrastructures are not being fully utilized because processing speed of communication control apparatuses becomes a bottleneck.

To solve such a problem, the applicant has developed a communication control apparatus capable of high speed processing (see Patent Document 1, for example).

[Patent Document 1] WO 2006/087832

### DISCLOSURE OF THE INVENTION

### Problem to be Solved by the Invention

For the development and operation of a communication control apparatus, performing a functional test thereof is vital. Accordingly, the inventors have recognized, for the development and operation of a high-speed communication control apparatus, the need for an appropriate testing apparatus to test such high-speed communication control apparatus.

The present invention has been made in view of such a situation, and a purpose thereof is to provide a technique for testing a communication control apparatus appropriately.

### Means for Solving the Problem

One aspect of the present invention relates to a testing apparatus. The testing apparatus is directed to testing a communication control apparatus comprising: a first memory unit which stores reference data to be referred to when a content of processing to be performed on data is determined; a search unit which searches input data for the reference data by comparing the data with the reference data; a second memory unit which stores a search result obtained by the search unit and the content of processing related to each other; and a processing unit which, on the basis of the search result, performs processing related to the search result on the data and outputs the processed data. The testing apparatus comprises: an output unit which outputs data to the communication control apparatus; a generating unit which generates data to be output by the processing unit after the processing unit normally processes data output to the communication control apparatus; an input unit which inputs data output by the communication control apparatus; and an inspection unit which compares data generated by the generating unit with data input by the input unit to check if the communication control apparatus operates normally.

Another aspect of the present invention also relates to a testing apparatus. The testing apparatus is directed to testing a communication control apparatus comprising: a first memory unit which stores reference data to be referred to when a content of processing to be performed on data is determined; a search unit which searches input data for the reference data by comparing the data with the reference data; a second memory unit which stores a search result obtained by the search unit and the content of processing related to each other; and a processing unit which, on the basis of the search result, performs processing related to the search result on the data and outputs the processed data. The testing apparatus comprises: a first output unit which outputs data to the communication control apparatus; a second output unit which outputs data to be output by the processing unit after the processing unit normally processes data output to the communication control apparatus; a first input unit which inputs data output by the communication control apparatus; a second input unit which inputs data output by the second output unit; and an inspection unit which compares data input by the first input unit with data input by the second input unit to check if the communication control apparatus operates normally.

The inspection unit may estimate the processing time of the communication control apparatus by measuring the difference between the time at which the first input unit inputs data and the time at which the second input unit inputs corresponding data.

These testing apparatuses may test a communication control apparatus of which the search unit is configured with a wired logic circuit. Also, the inspection unit may include a plurality of comparison circuits for comparing data bit by bit. The plurality of comparison circuits may be capable of performing a plurality of comparisons simultaneously in parallel.

Optional combinations of the aforementioned constituting elements, and implementations of the invention in the form of methods, apparatuses, systems, recording media and computer programs may also be practiced as additional modes of the present invention.

### ADVANTAGEOUS EFFECTS

The present invention provides a technique for testing a communication control apparatus appropriately.

### BRIEF DESCRIPTION OF THE DRAWINGS

FIG. 1 is a diagram that shows a configuration of a communication control system according to a base technology.

FIG. 2 is a diagram that shows a configuration of a conventional communication control apparatus.

FIG. 3 is a diagram that shows a configuration of a communication control apparatus according to the base technology.

FIG. 4 is a diagram that shows an internal configuration of a packet processing circuit.

FIG. 5 is a diagram that shows an internal configuration of a position detection circuit.

FIG. 6 is a diagram that shows an example of internal data of a first database.

FIG. 7 is a diagram that shows another example of internal data of the first database.

FIG. 8 is a diagram that shows yet another example of internal data of the first database.

FIG. 9 is a diagram that shows a configuration of comparison circuits included in a binary search circuit.

FIG. 10 is a diagram that shows an example of internal data of a second database.

FIG. 11 is a diagram that shows another example of internal data of the second database.

FIG. 12 is a diagram that shows another illustrative configuration of the communication control apparatus according to the base technology.

FIG. 13 is a diagram that shows a configuration of a testing apparatus according to an embodiment.

FIG. 14 is a diagram that shows a configuration of an inspection unit.

FIG. 15 is a diagram that shows another illustrative configuration of the testing apparatus according to the embodiment.

FIG. 16 is a diagram that shows yet another illustrative configuration of the testing apparatus according to the embodiment.

FIG. 17 is a diagram that shows still yet another illustrative configuration of the testing apparatus according to the embodiment.

FIG. 18 is a diagram that shows a further illustrative configuration of the testing apparatus according to the embodiment.

### EXPLANATION OF REFERENCE NUMERALS

10 communication control apparatus
12 communication control unit
14 switch control unit
20 packet processing circuit
30 search circuit
32 position detection circuit
33 comparison circuit
34 index circuit
35 comparison circuit
36 binary search circuit
40 process execution circuit
50 first database
60 second database
100 communication control system
110 operation monitoring apparatus
120 connection management apparatus
130 message output apparatus
140 log management apparatus
150 database server
160 URL database
200 testing apparatus
202 generating unit
204 output unit
206 input unit
208 inspection unit
220 comparison circuit
222 determination circuit
230 reporting unit
232 display apparatus
234 speaker
240 log recording unit
242 log retaining unit

### BEST MODE FOR CARRYING OUT THE INVENTION

### Base Technology

First, as a base technology, the configurations and the outline of operation of a communication control apparatus and its peripheral apparatuses will be described. Thereafter, there will be described, as an embodiment, a technique for testing a communication control apparatus.

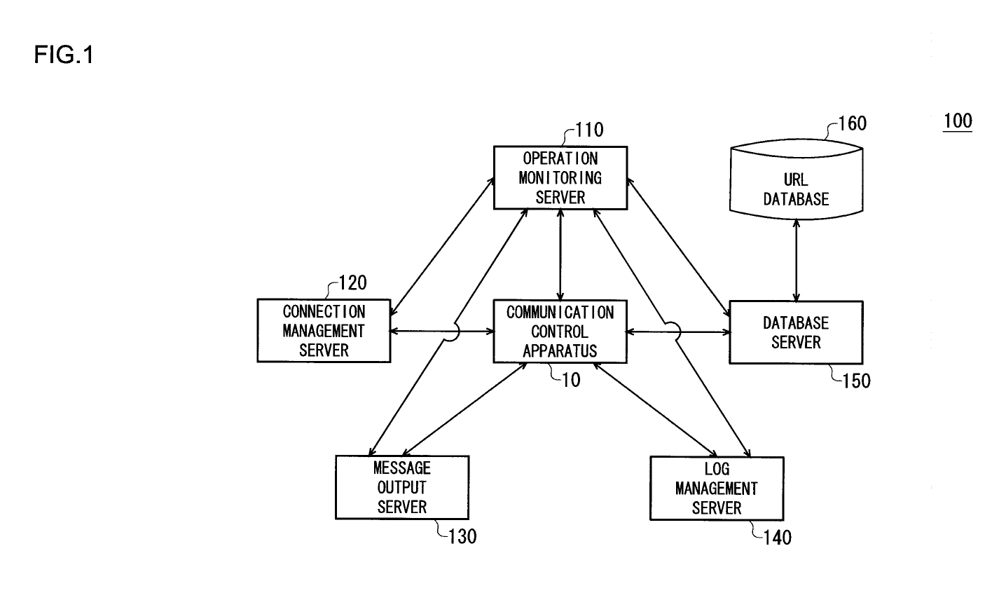

FIG. 1 shows a configuration of a communication control system according to the base technology. A communication control system 100 comprises a communication control apparatus 10 and various peripheral apparatuses provided to support the operation of the communication control apparatus 10. The communication control apparatus 10 of the base technology performs a URL filtering function provided by an Internet service provider or the like. The communication control apparatus 10 provided on a network path acquires a request for access to a content, analyzes the content, and determines whether or not the access to the content should be permitted. If the access to the content is permitted, the communication control apparatus 10 will transmit the access request to a server that retains the content. If the access to the content is prohibited, the communication control apparatus 10 will discard the access request and return a warning message or the like to the source of the request. The communication control apparatus 10 of the base technology receives an access request, such as an HTTP (HyperText Transfer Protocol) “GET” request message. The apparatus then searches a list of reference data for determining access permission to check if the URL of the content to be accessed appears in the list, so as to determine whether or not the access to the content should be permitted.

The peripheral apparatuses include an operation monitoring apparatus 110, a connection management apparatus 120, a message output apparatus 130, a log management apparatus 140 and a database server 150. The connection management apparatus 120 manages connection to the communication control apparatus 10. When the communication control apparatus 10 processes a packet transmitted from a cellular phone terminal, for example, the connection management apparatus 120 authenticates the user as a user of the communication control apparatus 10, based on information included in the packet, which uniquely identifies the cellular phone terminal. Once the user is authenticated, packets transmitted from the IP address, which is temporarily provided for the cellular phone terminal, will be transmitted to the communication control apparatus 10 and processed therein, without being authenticated by the connection management apparatus 120 during a certain period. The message output apparatus 130 outputs a message to the destination or the source of an access request, according to whether the communication control apparatus 10 has permitted the access. The log management apparatus 140 manages the operating history of the communication control apparatus 10. The database server 150 acquires the latest database from a URL database 160 and provides the database to the communication control apparatus 10. To update the database without halting the operation of the communication control apparatus 10, the apparatus may possess a backup database. The operation monitoring apparatus 110 monitors the operating state of the communication control apparatus 10 and its peripheral apparatuses including the connection management apparatus 120, message output apparatus 130, log management apparatus 140 and database server 150. The operation monitoring apparatus 110 has the highest priority in the communication control system 100 and performs supervisory control of the communication control apparatus 10 and all the peripheral apparatuses. Although the communication control apparatus 10 is configured with a dedicated hardware circuit, as will be described later, the operation monitoring apparatus 110 can monitor the operating state even while the communication control apparatus 10 is in operation, by inputting to or outputting from the communication control apparatus 10 the data for monitoring by means of a boundary-scan circuit based on the technique described in Japanese Patent No. 3041340 filed by the present applicant or other techniques.

In the communication control system 100 of the base technology, as will be described below, the communication control apparatus 10, configured with a dedicated hardware circuit for faster operation, is controlled by using a group of peripheral apparatuses connected thereto and having various functions. Accordingly, by suitably replacing the software of the group of apparatuses, a wide variety of functions can be achieved with a similar configuration. Thus, the base technology provides such communication control system having high flexibility.

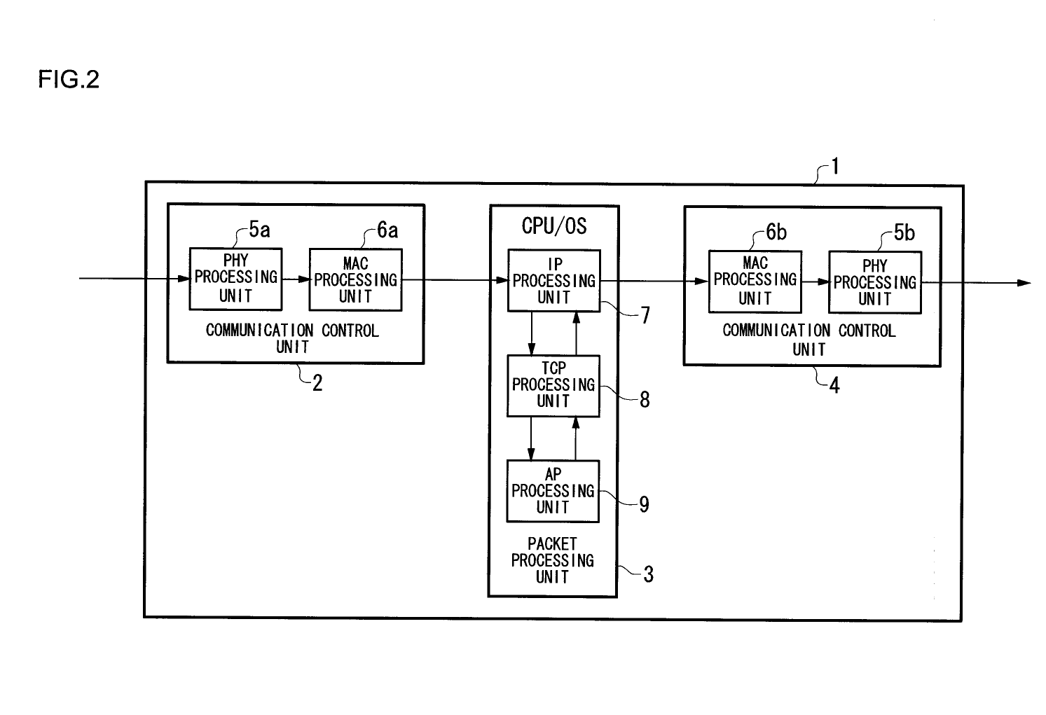

FIG. 2 shows a configuration of a conventional communication control apparatus 1. The conventional communication control apparatus 1 comprises a communication control unit 2 on the receiving side, a packet processing unit 3, and a communication control unit 4 on the sending side. The communication control units 2 and 4 include PHY processing units 5a and 5b for performing physical layer processing of packets, and MAC processing units 6a and 6b for performing MAC layer processing of packets, respectively.

The packet processing unit 3 includes protocol processing units for performing protocol-specific processing, such as an IP processing unit 7 for performing IP (Internet Protocol) processing and a TCP processing unit 8 for performing TCP (Transport Control Protocol) processing. The packet processing unit 3 also includes an AP processing unit 9 for performing application layer processing. The AP processing unit 9 performs filtering or other processing according to data included in a packet.

The packet processing unit 3 of the conventional communication control apparatus 1 is implemented by software, using a general-purpose processor, or CPU, and an OS running on the CPU. With such configuration, however, the performance of the communication control apparatus 1 depends on the performance of the CPU, hampering the creation of a communication control apparatus capable of high-speed processing of a large volume of packets. For example, a 64-bit CPU can process only up to 64 bits at a time, and hence, there has existed no communication control apparatus having a higher performance than this. In addition, since the conventional communication control apparatus is predicated on the presence of an OS with versatile functionality, the possibility of security holes cannot be eliminated completely, requiring maintenance work including OS upgrades.

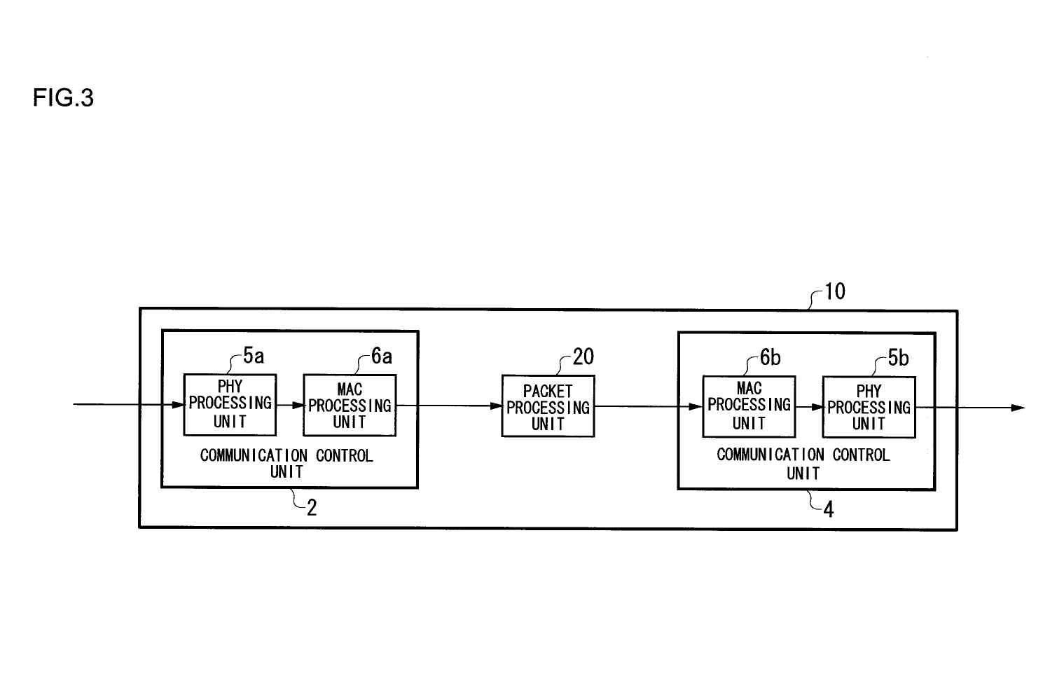

FIG. 3 shows a configuration of a communication control apparatus in the base technology. The communication control apparatus 10 comprises a packet processing circuit 20 configured with dedicated hardware employing a wired logic circuit, instead of the packet processing unit 3 that is implemented by software including a CPU and an OS in the conventional communication control apparatus 1 shown in FIG. 2. By providing a dedicated hardware circuit to process communication data, rather than processing it with an OS and software running on a general-purpose processing circuit such as CPU, the performance limitations posed by the CPU or OS can be overcome, enabling a communication control apparatus having high throughput.

For example, a case will be considered here in which search is conducted in packet filtering or the like to check if the data in a packet includes reference data, which serves as criteria for filtering. When a CPU is used to compare the communication data with the reference data, there occurs a problem in that, since only 64-bit data can be compared at a time, the processing speed cannot be improved beyond such CPU performance. Since the CPU needs to repeat the process of loading 64 bits of communication data into a memory and comparing it with the reference data, the memory load time becomes a bottleneck that limits the processing speed.

In the base technology, by contrast, a dedicated hardware circuit configured with a wired logic circuit is provided to compare communication data with reference data. This circuit includes multiple comparators arranged in parallel, so as to enable the comparison of data having a length greater than 64 bits, such as 1024 bits. By providing dedicated hardware in such manner, bit matching can be simultaneously performed on a large number of bits in parallel. Since 1024-bit data can be processed at a time, while the conventional communication control apparatus 1 using a CPU processes only 64 bits, the processing speed can be improved remarkably. Increasing the number of comparators will improve the throughput, but also increase the cost and size of the apparatus. Accordingly, an optimal hardware circuit may be designed in accordance with the desired performance, cost or size. The dedicated hardware circuit may be configured with an FPGA (Field Programmable Gate Array), etc.

Since the communication control apparatus 10 of the base technology is configured with dedicated hardware employing a wired logic circuit, it does not require any OS (Operating System). This can eliminate the need for the installation, bug fixes, or version upgrades of an OS, thereby reducing the cost and man-hours required for administration and maintenance. Also, unlike CPUs requiring versatile functionality, the communication control apparatus 10 does not include any unnecessary functions or use needless resources, and hence, reduced cost, a smaller circuit area or improved processing speed can be expected. Furthermore, again unlike conventional OS-based communication control apparatuses, the absence of unnecessary functions decreases the possibility of security holes and thus enhances the tolerance against attacks from malicious third parties over a network.

The conventional communication control apparatus 1 processes packets using software predicated on a CPU and an OS. Therefore, all packet data needs to be received before protocol processing is performed, and then the data is passed to an application. In contrast, since packet processing is performed by a dedicated hardware circuit in the communication control apparatus 10 of the base technology, all packet data need not be received before starting the processing; upon reception of necessary data, the processing can be started at any given point in time without waiting for the reception of subsequent data. For example, position detection processing in a position detection circuit, which will be described later, may be started at the time when position identification data for identifying the position of comparison target data is received. Thus, various types of processing can be performed in parallel without waiting for the reception of all data, reducing the time required to process packet data.

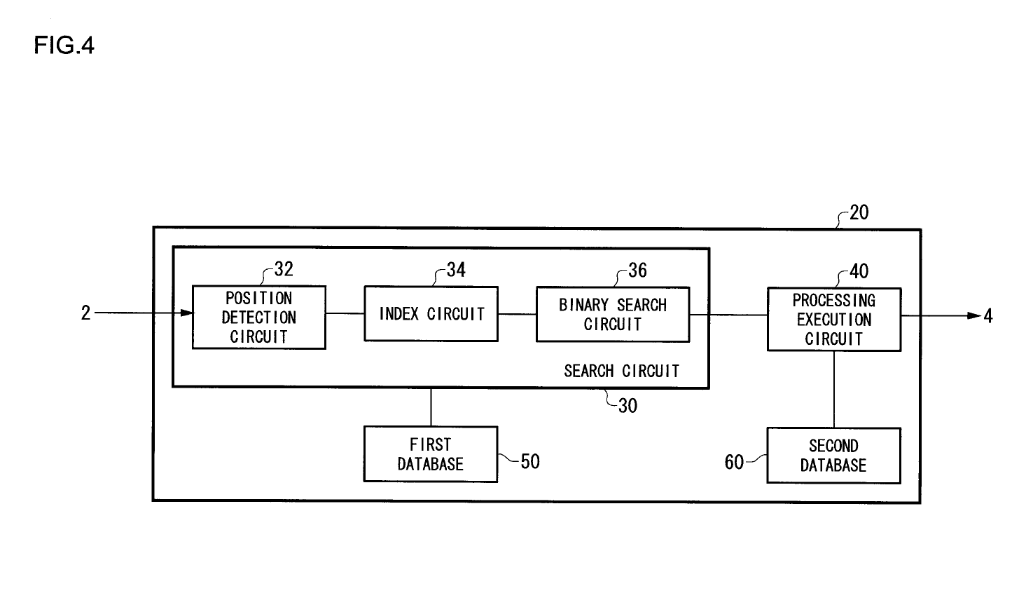

FIG. 4 shows an internal configuration of the packet processing circuit. The packet processing circuit 20 comprises: a first database 50 for storing reference data, which is referred to when processing to be performed on communication data is determined; a search circuit 30 for searching received communication data for the reference data by comparing the two; a second database 60 for storing a search result of the search circuit 30 and a content of processing to be performed on the communication data, which are related to each other; and a process execution circuit 40 for processing the communication data based on the search result of the search circuit 30 and the conditions stored in the second database 60.

The search circuit 30 includes: a position detection circuit 32 for detecting the position of comparison target data, which is to be compared with reference data, in communication data; an index circuit 34 which serves as an example of a determination circuit that determines which range the comparison target data belongs to among three or more ranges, into which the reference data stored in the first database 50 is divided; and a binary search circuit 36 for searching the determined range for the reference data that matches the comparison target data. The reference data may be searched for the comparison target data using any search technique, and a binary search method is used in the base technology.

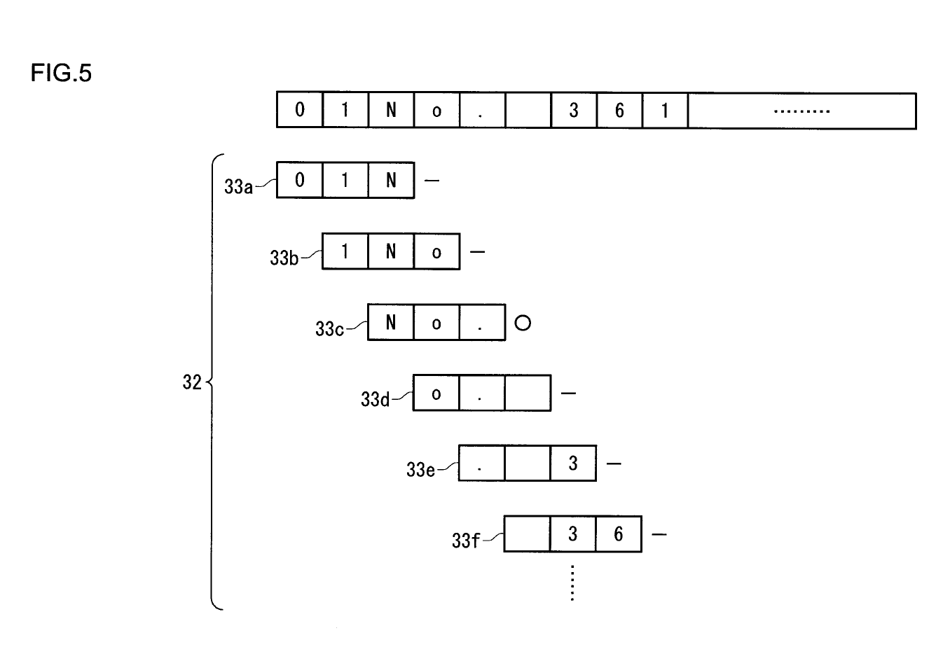

FIG. 5 shows an internal configuration of the position detection circuit. The position detection circuit 32 includes multiple comparison circuits 33a-33f that compare communication data with position identification data for identifying the position of comparison target data. While six comparison circuits 33a-33f are provided here, the number of comparison circuits may be arbitrary, as will be described later. To the comparison circuits 33a-33f are input pieces of communication data, with each piece shifted from the preceding one by a predetermined data length, such as 1 byte. These multiple comparison circuits 33a-33f then simultaneously compare the respective communication data with the position identification data to be detected in parallel.

The base technology will be described by way of example for explaining the operation of the communication control apparatus 10, in which a character string “No. ###” in communication data is detected, the number “###” included in the character string is then compared with reference data, and if the number matches the reference data, the packet will be allowed to pass, while, if they do not match, the packet will be discarded.

In the example of FIG. 5, communication data “01No. 361 . . . ” is input to the comparison circuits 33a-33f with a shift of one character each, and position identification data “No.” for identifying the position of the number “###” is sought to be detected in the communication data. More specifically, “01N” is input to the comparison circuit 33a, “1No” to the comparison circuit 33b, “No.” to the comparison circuit 33c, “o.” to the comparison circuit 33d, “0.3” to the comparison circuit 33e, and “36” to the comparison circuit 33f. Then, the comparison circuits 33a-33f simultaneously perform comparisons with the position identification data “No.”. Consequently, there is found a match with the comparison circuit 33c, indicating that the character string “No.” exists at the third character from the top of the communication data. Thus, it is found that the numeral data as comparison target data exists subsequent to the position identification data “No.” detected by the position detection circuit 32.

When the same processing is performed by a CPU, since the comparison process needs to be serially performed one by one from the top, such as comparing character strings “01N” and “No.” before comparing “1No” and “No.”, no improvement of detection speed can be expected. In the communication control apparatus 10 of the base technology, in contrast, providing the multiple comparison circuits 33a-33f in parallel enables simultaneous parallel comparison processing, which could not have been performed with a CPU, improving the processing speed significantly. Providing more comparison circuits will improve the detection speed, as more characters can be compared simultaneously. In consideration of cost or size, a sufficient number of comparison circuits may be provided to achieve a desired detection speed.

Aside from detecting position identification data, the position detection circuit 32 may also be used as a circuit for detecting character strings for various purposes. Moreover, the position detection circuit 32 may be configured to detect position identification data in units of bits, not just as a character string.

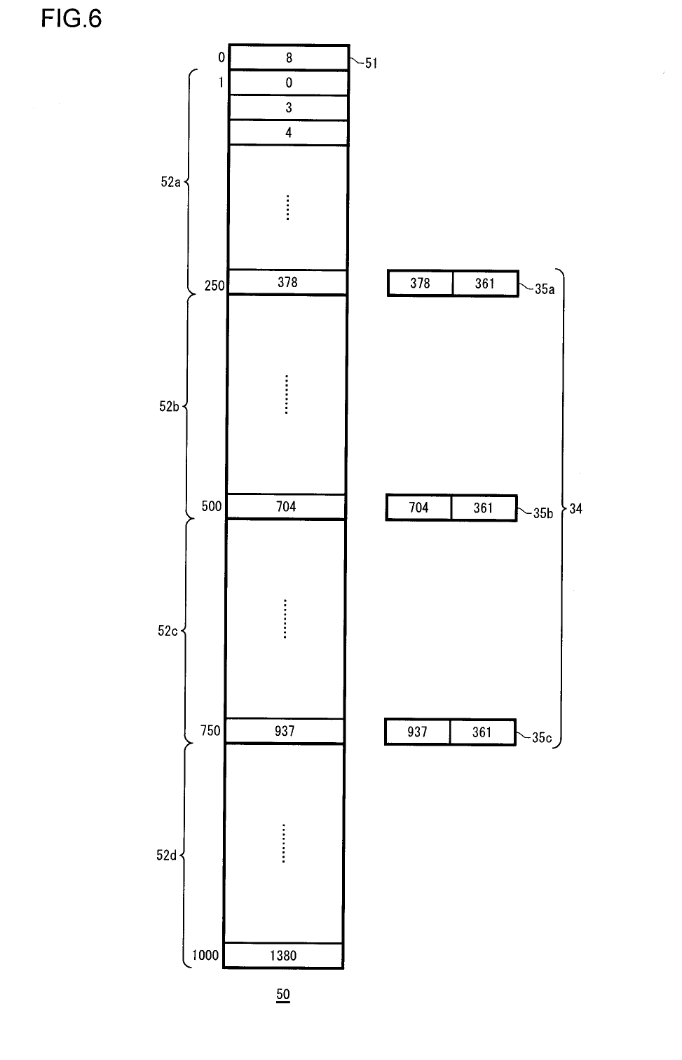

FIG. 6 shows an example of internal data of the first database. The first database 50 stores reference data, which is referred to when processing on packets, such as filtering, routing, switching, or replacement, is determined.

The pieces of reference data are sorted according to some sort conditions. In the example of FIG. 6, 1000 pieces of reference data are stored.

The top record of the first database 50 contains an offset 51 which indicates the position of comparison target data in communication data. For example, in a TCP packet, the data configuration within the packet is determined in units of bits. Therefore, if the position of flag information or the like for determining the processing on the packet is given in the form of the offset 51, the processing can be determined by comparing only necessary bits, thus improving the processing efficiency. Also, even when the configuration of packet data is changed, it can be addressed by modifying the offset 51 accordingly. The first database 50 may store the data length of comparison target data. In this case, since the comparison can be performed by operating only a required number of comparators, the search efficiency can be improved.

The index circuit 34 determines which range comparison target data belongs to among three or more ranges, such as 52a-52d, into which reference data stored in the first database 50 is divided. In the example of FIG. 6, the 1000 pieces of reference data are divided into four ranges 52a-52d, i.e., 250 pieces each in a range. The index circuit 34 includes multiple comparison circuits 35a-35c, each of which compares a piece of reference data at the border of the range with the comparison target data. Since the comparison circuits 35a-35c simultaneously compare the pieces of reference data at the borders with the comparison target data in parallel, which range the comparison target data belongs to can be determined by a single operation of comparison processing.

The pieces of reference data at the borders to be input to the comparison circuits 35a-35c of the index circuit 34 may be set by an apparatus provided outside the communication control apparatus 10. Alternatively, reference data at predetermined positions in the first database 50 may be set in advance to be automatically input as such. In the latter case, even when the first database 50 is updated, the reference data at the predetermined positions in the first database 50 are automatically input to the comparison circuits 35a-35c. Therefore, the communication control processing can be performed immediately without initialization or the like.

As mentioned previously, CPU-based binary search cannot make multiple comparisons at the same time. In the communication control apparatus 10 of the base technology, in contrast, providing the multiple comparison circuits 35a-35c in parallel enables simultaneous parallel comparison processing, with a significant improvement in the search speed.

After the index circuit 34 determines the relevant range, the binary search circuit 36 performs a search using a binary search method. The binary search circuit 36 divides the range determined by the index circuit 34 further into two and subsequently compares the piece of reference data lying at the border with the comparison target data, thereby determining which range the comparison target data belongs to. The binary search circuit 36 includes multiple comparison circuits for comparing, bit by bit, reference data with comparison target data. For example, in the base technology are provided 1024 comparison circuits to perform bit matching on 1024 bits simultaneously. When the range to which the comparison target data belongs is determined between the two split ranges, the determined range is further divided into two. Then, the reference data lying at the border is read out to be compared with the comparison target data. Thereafter, this processing is repeated to narrow the range further until reference data that matches the comparison target data is eventually found.

The operation will now be described in more detail in conjunction with the foregoing example. In the communication data shown in FIG. 5, the number “361” is the comparison target data that follows the position identification data “No.”. Since a single space character intervenes between the position identification data “No.” and the comparison target data “361”, the offset 51 is set to “8” bits in order to exclude the space from the comparison target data. Accordingly, the binary search circuit 36 skips the first “8” bits, or 1 byte, of the communication data subsequent to the position identification data “No.” and reads the following “361” as the comparison target data.

Each of the comparison circuits 35a-35c of the index circuit 34 receives “361” as comparison target data. As for reference data, the comparison circuit 35a receives “378”, which lies at the border of the ranges 52a and 52b. Similarly, the comparison circuit 35b receives reference data “704” lying at the border of the ranges 52b and 52c, and the comparison circuit 35c receives reference data “937” lying at the border of the ranges 52c and 52d. The comparison circuits 35a-35c then perform comparisons simultaneously, determining that the comparison target data “361” belongs to the range 52a. Subsequently, the binary search circuit 36 searches the reference data for the comparison target data “361”.

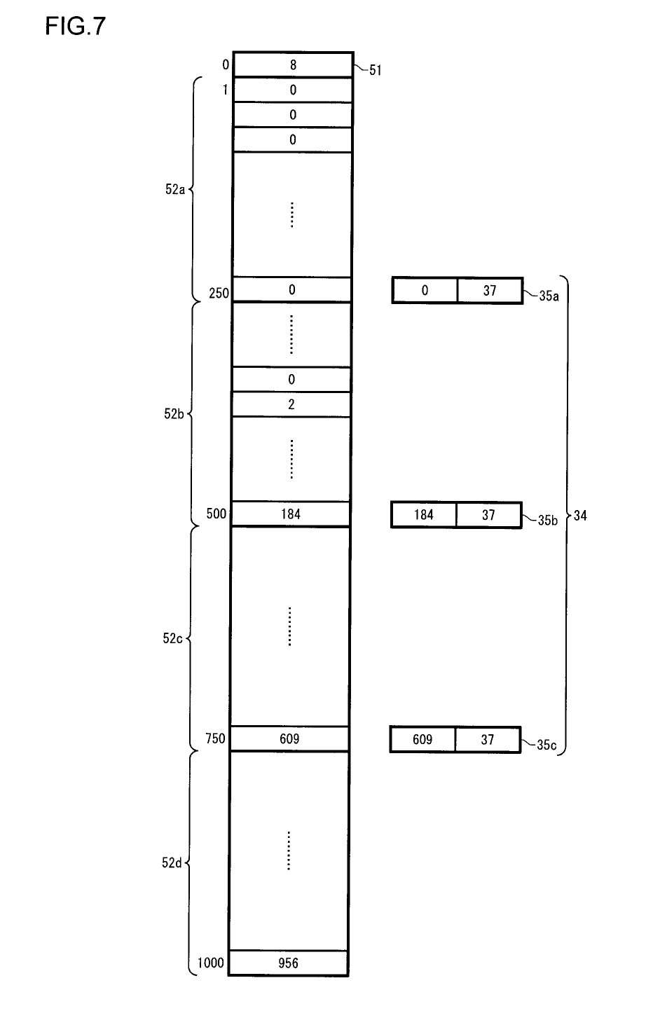

FIG. 7 shows another example of internal data of the first database. In the example shown in FIG. 7, the number of pieces of reference data is smaller than the number of pieces of data storable in the first database 50, i.e., 1000 in this case. In such instance, the first database 50 stores the pieces of reference data in descending order, starting with the last data position therein. Then, 0 is stored in the rest of the data positions. The database is loaded with data not from the top but from the bottom of the loading area, and all the vacancies occurring in the front of the loading area, if any, are replaced with zero. Consequently, the database is fully loaded at any time, so that the maximum time necessary for a binary search will be constant. Moreover, if the binary search circuit 36 reads reference data “0” during a search, the circuit can identify the range without making a comparison, as the comparison result is obvious, and can proceed to the next comparison. Consequently, the search speed can be improved.

In CPU-based software processing, the first database 50 stores pieces of reference data in ascending order, from the first data position therein. In the rest of data positions will be stored a maximum value or the like, and in such case, the skip of comparison processing as described above cannot be made during a binary search. The comparison technique described above can be implemented by configuring the search circuit 30 with a dedicated hardware circuit.

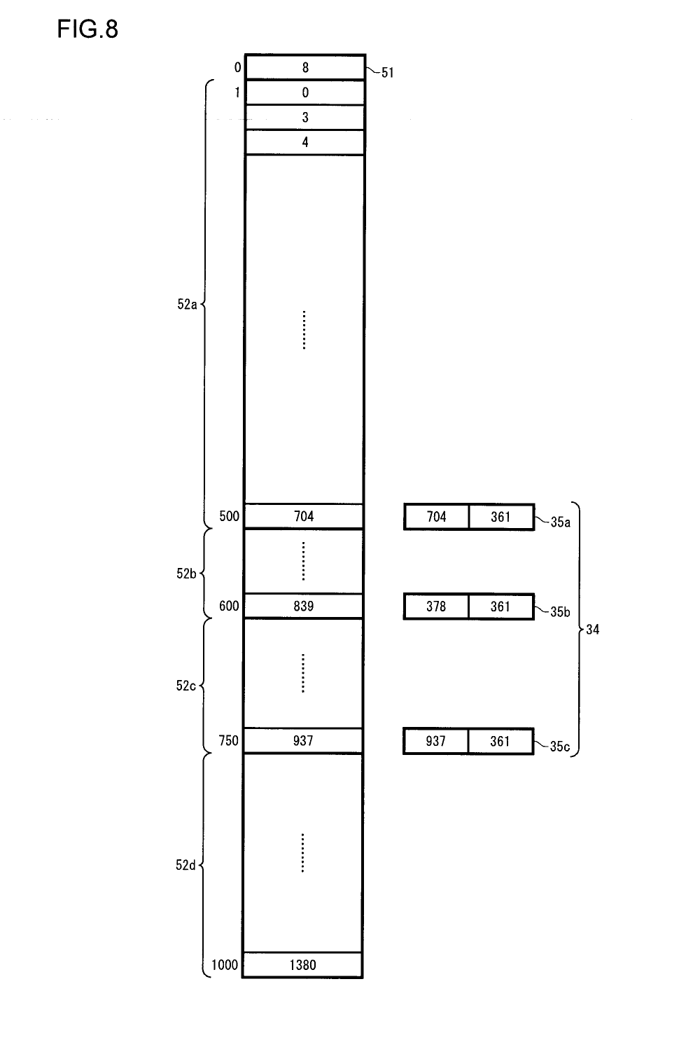

FIG. 8 shows yet another example of internal data of the first database. In the example shown in FIG. 8, the reference data is not evenly divided into three or more ranges, but unevenly divided into ranges that accommodate different numbers of pieces of data, such as 500 pieces in the range 52a and 100 pieces in the range 52b. These ranges may be determined depending on the distribution of frequencies with which reference data occurs in communication data. Specifically, the ranges may be determined so that the sums of the frequencies of occurrence of reference data belonging to the respective ranges are almost the same. Accordingly, the search efficiency can be improved. The reference data to be input to the comparison circuits 35a-35c of the index circuit 34 may be modifiable from the outside. In such case, the ranges can be dynamically set, so that the search efficiency will be optimized.

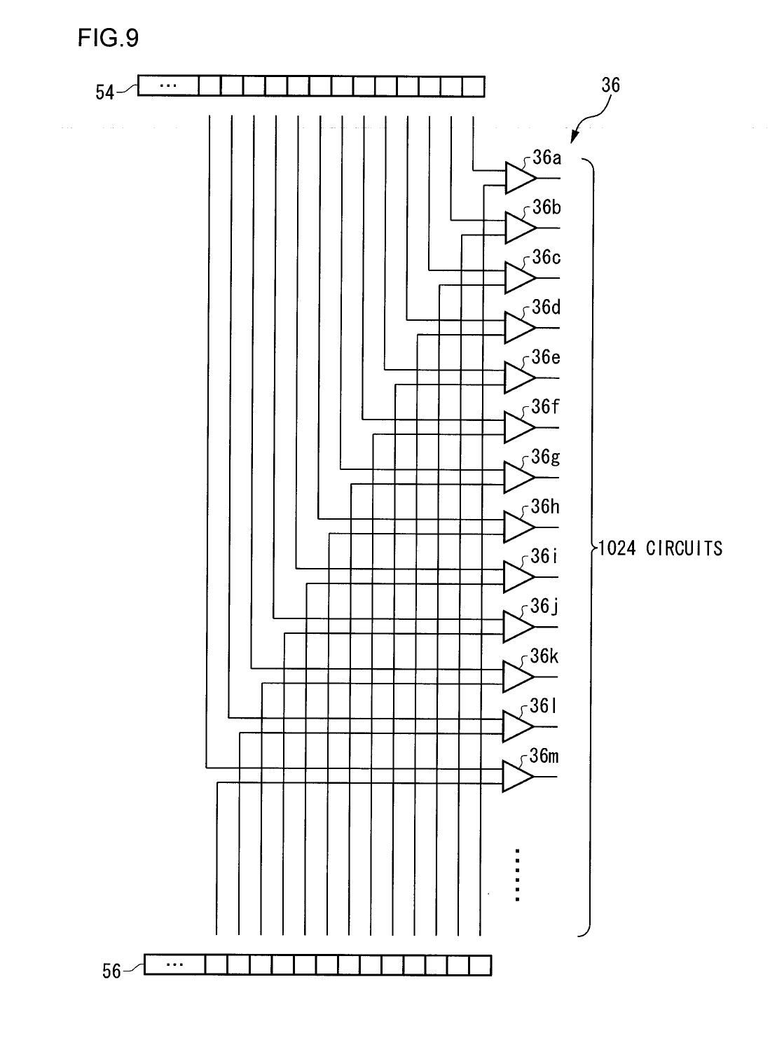

FIG. 9 shows a configuration of comparison circuits included in the binary search circuit. As mentioned previously, the binary search circuit 36 includes 1024 comparison circuits, such as 36a, 36b, . . . . Each of the comparison circuits 36a, 36b, etc. receives 1 bit of reference data 54 and 1 bit of comparison target data 56 to compare the bits in value. The comparison circuits 35a-35c of the index circuit 34 have similar internal configurations. Since the comparison processing is thus performed by a dedicated hardware circuit, a large number of comparison circuits can be operated in parallel to compare a large number of bits at a time, thereby speeding up the comparison processing.

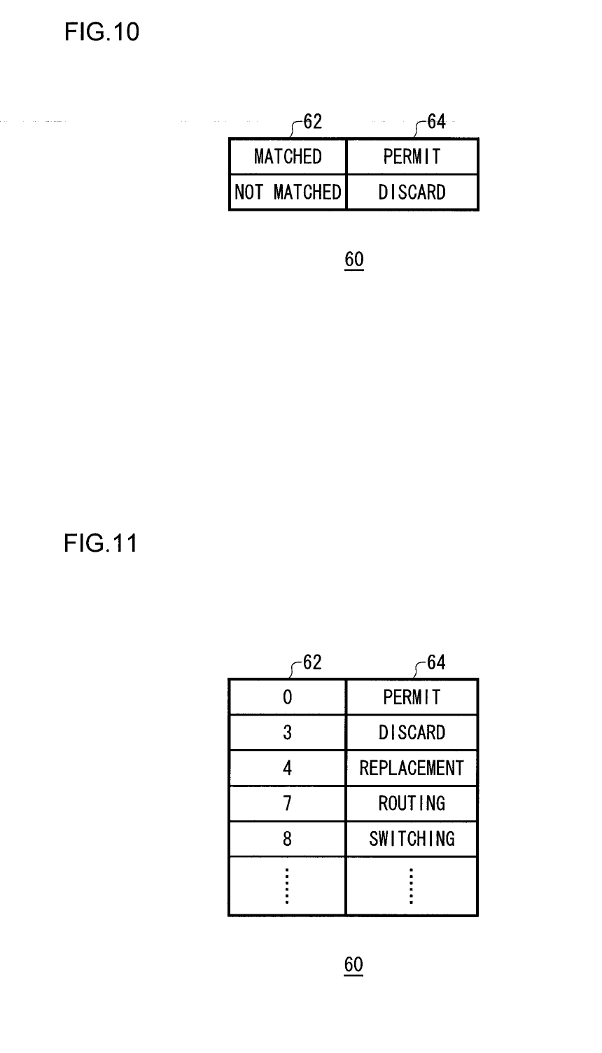

FIG. 10 shows an example of internal data of the second database. The second database 60 includes a search result field 62, which contains a search result of the search circuit 30, and a processing content field 64, which contains a processing content to be performed on communication data. The database stores the search results and the processing contents related to each other. In the example of FIG. 10, conditions are established such that a packet will be allowed to pass if its communication data contains reference data; if not, the packet will be discarded. The process execution circuit 40 searches the second database 60 for a processing content based on the search result and performs the processing on the communication data. The process execution circuit 40 may also be configured with a wired logic circuit.

FIG. 11 shows another example of internal data of the second database. In the example of FIG. 11, the processing content is set for each piece of reference data. With regard to packet replacement, replacement data may be stored in the second database 60. As for packet routing or switching, information on the route may be stored in the second database 60. The process execution circuit 40 performs processing, such as filtering, routing, switching, or replacement, which is specified in the second database 60, in accordance with the search result of the search circuit 30. When the processing content is set for each piece of reference data, as shown in FIG. 11, the first database 50 and the second database 60 may be merged with each other.

The first database and the second database are configured to be rewritable from the outside. By replacing these databases, various types of data processing and communication control can be achieved using the same communication control apparatus 10. Also, multistage search processing may be performed by providing two or more databases that store reference data to be searched. In such instance, more complicated conditional branching may be performed by providing two or more databases that store search results and processing contents related to each other. When multiple databases are thus provided to conduct multistage search, a plurality of the position detection circuits 32, the index circuits 34, the binary search circuits 36, etc. may also be provided.

The data intended for the foregoing comparison may be compressed by the same compression logic. If both the source data and the target data to be compared are compressed by the same method, the comparison can be performed in the same manner as usual, thus reducing the amount of data to be loaded for comparison. The smaller amount of data to be loaded can reduce the time required to read out the data from the memory, thereby reducing the overall processing time. Moreover, the number of comparators can be also reduced, which contributes to the miniaturization, weight saving, and cost reduction of the apparatus. The data intended for comparison may be stored in a compressed form, or may be read out from the memory and compressed before comparison.

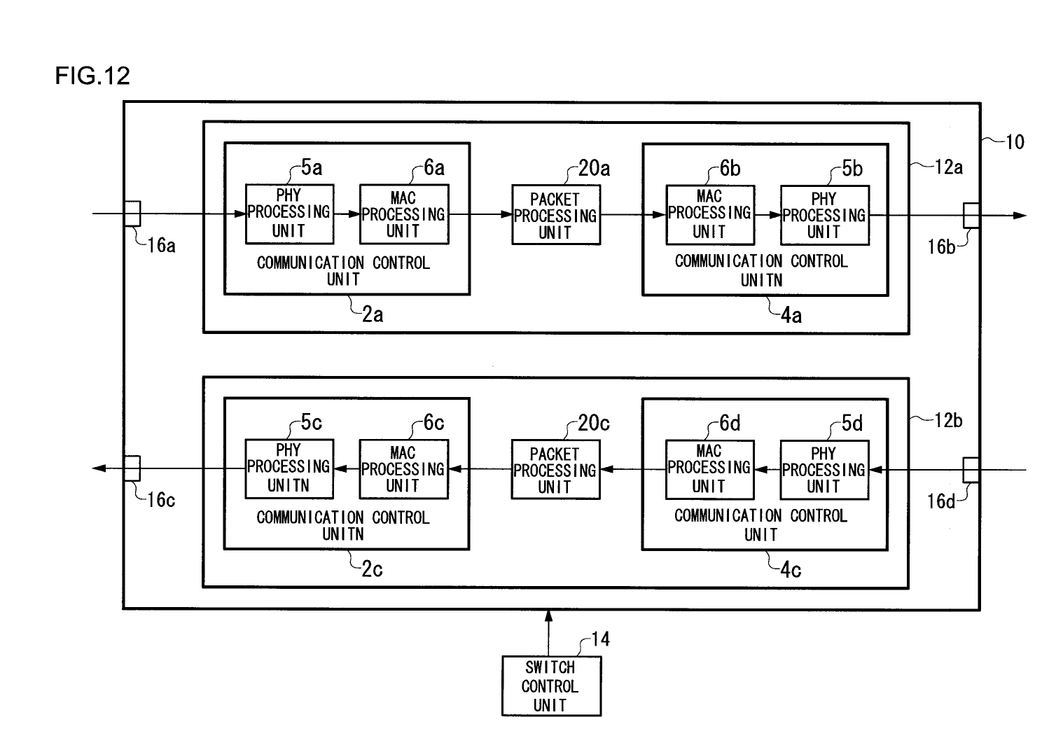

FIG. 12 shows another illustrative configuration of the communication control apparatus in the base technology. The communication control apparatus 10 shown in this diagram has two communication control units 12, each of which has the same configuration as the communication control apparatus 10 shown in FIG. 3. There is also provided a switch control unit 14 for controlling the operation of the individual communication control units 12. Each of the communication control units 12 has two input/output interfaces 16 and is connected to two networks, upstream and downstream, via the respective input/output interfaces 16. The communication control units 12 receive communication data from either one of the networks and output processed data to the other. The switch control unit 14 switches the inputs and outputs of the input/output interfaces 16 provided for the individual communication control units 12, thereby switching the directions of the flow of communication data in the communication control units 12. This allows communication control not only in one direction but also in both directions.

The switch control unit 14 may provide control such that: either one of the communication control units 12 processes inbound packets and the other processes outbound packets; both the units process inbound packets; or both the units process outbound packets. Consequently, the directions of communications to control can be changed depending on, for example, the traffic status or intended purpose.

The switch control unit 14 may acquire the operation state of the respective communication control units 12 and may switch the direction of communication control according thereto. For example, when one of the communication control units 12 is in a standby state and the other communication control unit 12 is in operation, the unit on standby may be activated as a substitute upon detection of the unit in operation stopping due to a failure or other reasons. This can improve the fault tolerance of the communication control apparatus 10. Also when one of the communication control units 12 needs maintenance such as a database update, the other communication control unit 12 may be operated as a substitute. Thus, appropriate maintenance can be performed without halting the operation of the communication control apparatus 10.

The communication control apparatus 10 may be provided with three or more communication control units 12. The switch control unit 14 may, for example, acquire the traffic status to control the direction of communications in the respective communication control units 12 so that more communication control units 12 are allocated for communication control processing in a direction handling higher traffic. This minimizes a drop in the communication speed, even when the traffic increases in one direction.

The plurality of communication control units 12 may share a part of the communication control unit 2 or 4. The units may also share a part of the packet processing circuit 20, too.

For the data processing apparatus stated above, the following aspects may be provided.

[Aspect 1]

A data processing apparatus comprising:

a first memory unit which stores reference data to be referred to when a content of processing to be performed on acquired data is determined;

a search unit which searches the data for the reference data by comparing the data with the reference data;

a second memory unit which stores a search result obtained by the search unit and the content of processing related to each other; and

a processing unit which, on the basis of the search result, performs processing related to the search result on the data, wherein

the search unit is configured with a wired logic circuit.

[Aspect 2]

The data processing apparatus of Aspect 1, wherein the wired logic circuit includes a plurality of first comparison circuits which compare the data with the reference data bit by bit.

[Aspect 3]

The data processing apparatus of Aspect 1, wherein the search unit includes a position detection circuit which detects in the data the position of comparison target data to be compared with the reference data.

[Aspect 4]

The data processing apparatus of Aspect 3, wherein the position detection circuit includes a plurality of second comparison circuits which compare the data with position identification data for identifying the position of the comparison target data, and wherein the plurality of second comparison circuits receive the data, each having a shift of a predetermined data length, and compare the data with the position identification data simultaneously in parallel.

[Aspect 5]

The data processing apparatus of Aspect 1 or 2, wherein the search unit includes a binary search circuit which searches the data for the reference data by binary search.

[Aspect 6]

The data processing apparatus of Aspect 5, wherein, when the number of pieces of the reference data is smaller than the number of pieces of data storable in the first memory unit, the reference data is stored in the first memory unit in descending order from the last data position, while 0 is stored in the rest of the data positions.

[Aspect 7]

The data processing apparatus of any one of Aspects 1 through 6, wherein the search unit includes a determination circuit which determines which range comparison target data to be compared with the reference data belongs to, among three or more ranges into which the plurality of pieces of reference data stored in the first memory unit are divided.

[Aspect 8]

The data processing apparatus of Aspect 7, wherein the determination circuit include a plurality of third comparison circuits which compare reference data at borders of the ranges with the comparison target data so that the plurality of third comparison circuits determine which of the three or more ranges the comparison target data belongs to simultaneously in parallel.

[Aspect 9]

The data processing apparatus of Aspect 8, wherein the reference data stored in predetermined positions of the first memory unit are input to the third comparison circuits as the reference data at the borders.

[Aspect 10]

The data processing apparatus of Aspect 7 or 8, wherein the ranges are determined depending on the distribution of frequencies with which the reference data occurs in the data.

[Aspect 11]

The data processing apparatus of any one of Aspects 1 through 10, wherein the first memory unit further stores information indicating the position of the comparison target data in the data, and wherein the search unit extracts the comparison target data based on the information indicating the position.

[Aspect 12]

The data processing apparatus of any one of Aspects 1 through 11, wherein the first memory unit or the second memory unit is configured to be rewritable from the outside.

[Aspect 13]

The data processing apparatus of any one of Aspects 1 through 12, wherein, when the search unit acquires data in a communication packet to be compared with the reference data, the search unit starts comparing the data and the reference data without waiting for the acquisition of all data of the communication packet.

[Aspect 14]

A data processing apparatus comprising a plurality of the data processing apparatuses of any one of Aspects 1 through 13, wherein the data processing apparatuses each have two interfaces which input or output data to or from a communication line, and the direction of processing of the data is changeably controlled by switching the inputs and outputs of the respective interfaces.

### Embodiment

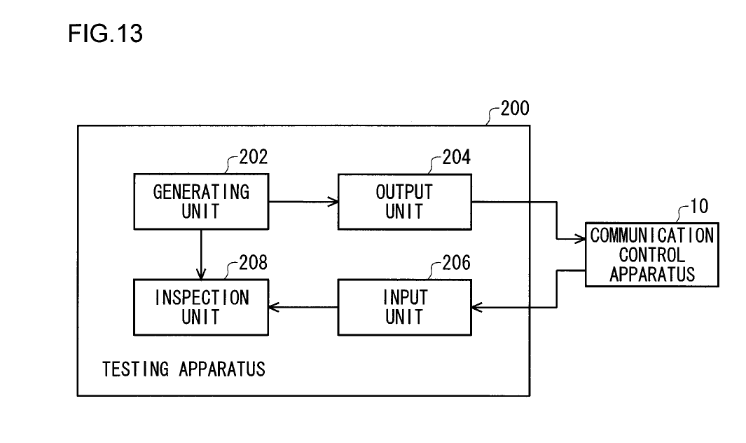

FIG. 13 shows a configuration of a testing apparatus 200 according to the embodiment. The testing apparatus 200 comprises a generating unit 202, an output unit 204, an input unit 206, and an inspection unit 208. In terms of hardware components, these unit structures may be realized by a CPU or memory of any given computer, a memory-loaded program, or the like. Here is shown a functional block configuration that is realized by cooperation of such components. Thus, it would be understood by those skilled in the art that these function blocks can be realized in a variety of forms by hardware only, software only, or a combination thereof.

The generating unit 202 generates test data to be output to the communication control apparatus 10 and also generates answer data that should be output by the process execution circuit 40 of the communication control apparatus 10 after the circuit 40 processes the test data normally. If the communication control apparatus 10 is provided to perform packet filtering, for example, the generating unit 202 will generate test data that contain a packet to be passed and a packet to be blocked together and also generate answer data that contain a packet to be passed but do not contain a packet to be blocked. If the communication control apparatus 10 performs processing for converting data contained in a packet according to a given algorithm, the generating unit 202 will generate a sample of a packet transmitted as test data and also generate answer data by converting the data in the packet according to the given algorithm.

The generating unit 202 may generate test data and answer data in advance and store the data in a storage apparatus, such as a hard disk or a memory. In such case, when a test is started, the generating unit 202 reads test data from the storage apparatus and transmits the data to the output unit 204; the generating unit 202 also reads answer data from the storage apparatus and transmits the data to the inspection unit 208. The output unit 204 may directly read test data from the storage apparatus. Similarly, the inspection unit 208 may directly read answer data from the storage apparatus.

Test data and answer data may be generated and input to the testing apparatus 200 by another apparatus. In such case, the testing apparatus 200 includes, instead of the generating unit 202, a configuration for acquiring test data and answer data from the another apparatus.

The output unit 204 outputs test data to the communication control apparatus 10. The input unit 206 inputs result data output by the communication control apparatus 10. The inspection unit 208 compares answer data generated by the generating unit 202 with result data input by the input unit 206 sequentially from the top of both the data, so as to check if the communication control apparatus 10 operates normally.

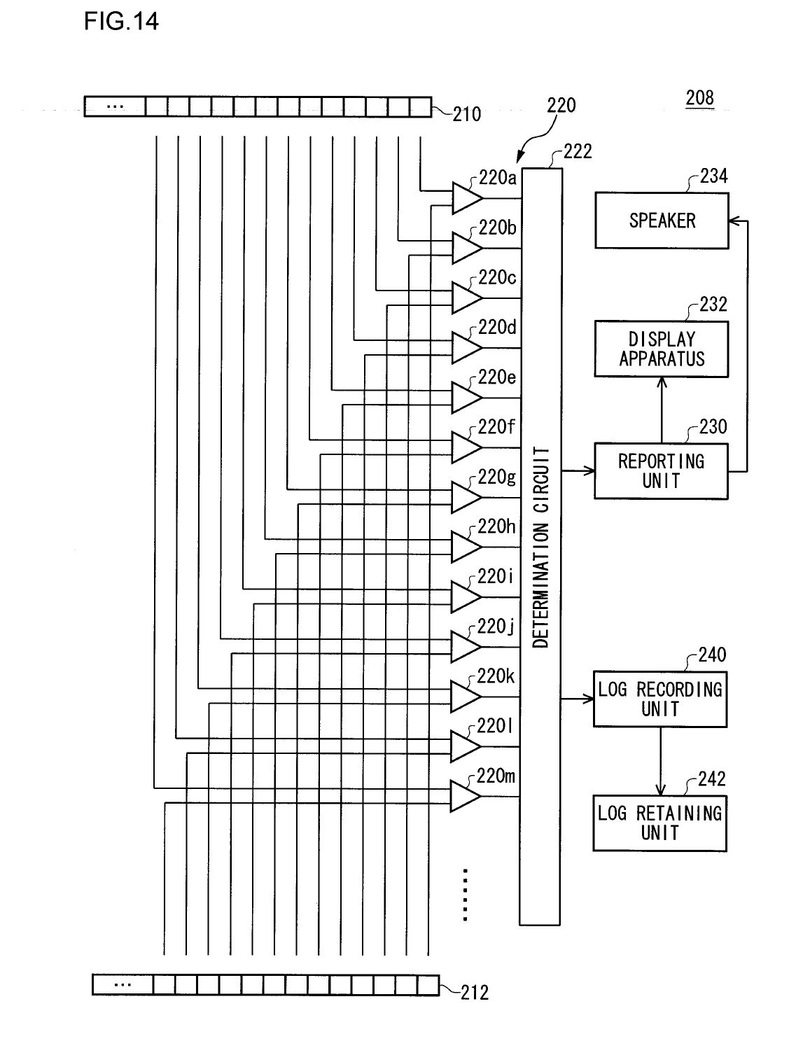

FIG. 14 shows a configuration of the inspection unit 208. As with the binary search circuit 36 shown in FIG. 9, the inspection unit 208 comprises a comparison circuit 220 that includes multiple comparators 220a, 220b, etc. for comparing, bit by bit, answer data 210 generated by the generating unit 202 with result data 212 input by the input unit 206. The multiple comparators 220a, 220b, etc. may be capable of performing multiple comparisons simultaneously in parallel. This enables high-speed comparisons among a large amount of data, so that the time required for a test can be remarkably reduced. Also, the capacity of a buffer for temporarily storing the answer data 210 and result data 212 to be compared can be reduced.

The communication control apparatus 10 described in the base technology is capable of high-speed processing because the packet processing circuit 20 thereof including the search circuit 30 is configured with a wired logic circuit and comprises the position detection circuit 32, which detects target data to be compared at high speed, and the index circuit 34 and binary search circuit 36, which enable high-speed binary search. When testing such communication control apparatus 10, the testing apparatus 200 therefor should preferably be also capable of high-speed operation. As stated previously, the testing apparatus 200 of the present embodiment enables high-speed testing commensurate with the communication control apparatus 10 capable of high-speed operation.

A determination circuit 222 acquires comparison results from the multiple comparators 220a, 220b, etc. and determines if the answer data 210 matches the result data 212. If the answer data 210 does not match the result data 212, a reporting unit 230 will report the error by displaying an error message on a display apparatus 232 or outputting an audible alarm from a speaker 234. A log recording unit 240 records the details of an error as an error log, which is retained by a log retaining unit 242. The error log may include the position of data that has caused the error, the answer data or output data at the time, etc. The reporting unit 230 may allow a printer or the like, not illustrated, to print an error message. Also, the log recording unit 240 may allow a printer or the like, not illustrated, to print an error log.

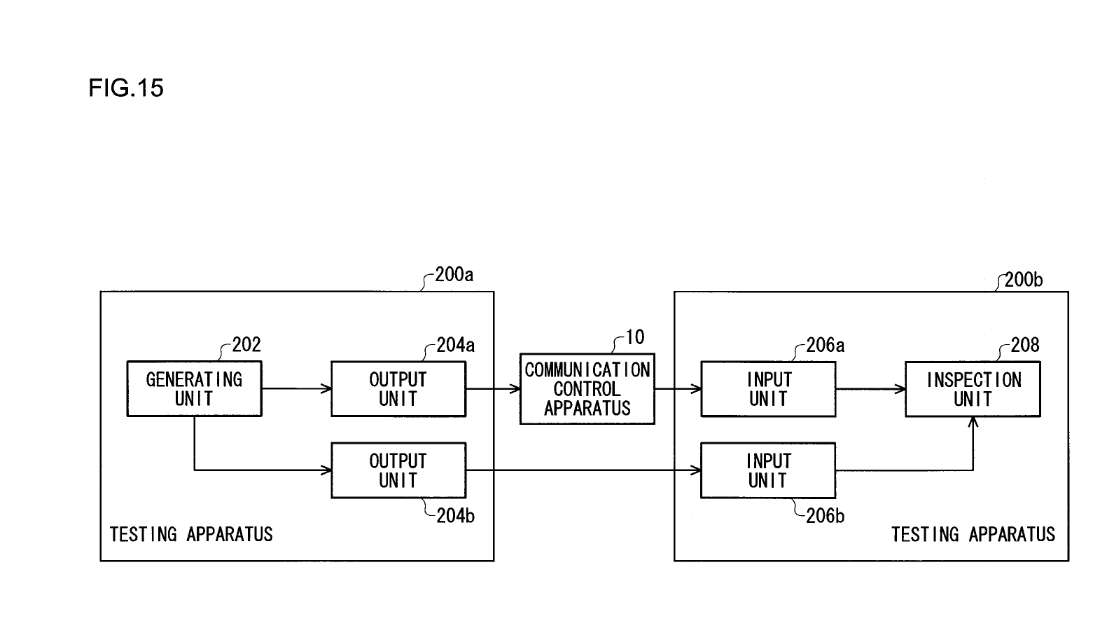

FIG. 15 shows another illustrative configuration of the testing apparatus according to the embodiment. In the example shown in FIG. 13, the generating unit 202, output unit 204, input unit 206, and inspection unit 208 are provided in the same testing apparatus 200; however, in the example shown in FIG. 15, a testing apparatus 200a on the input side of the communication control apparatus 10 comprises the generating unit 202, and output units 204a and 204b, and a testing apparatus 200b on the output side of the communication control apparatus 10 comprises input units 206a and 206b, and the inspection unit 208.

The output unit 204a outputs, to the communication control apparatus 10, test data generated by the generating unit 202. The output unit 204b outputs, to the testing apparatus 200b, answer data generated by the generating unit 202. The input unit 206a inputs result data output by the communication control apparatus 10. The input unit 206b inputs answer data output by the output unit 204b. Other configurations and operations are the same as those described in the example of FIG. 13.

The inspection unit 208 may estimate the processing time of the communication control apparatus 10, by measuring the difference between the time at which the input unit 206a inputs data and the time at which the input unit 206b inputs corresponding data. In such instance, in order to measure the throughput of the communication control apparatus 10 more accurately, it is preferable to equalize the communication capacity of the communication path from the output unit 204a via the communication control apparatus 10 to the input unit 206a, with that of the communication path from the output unit 204b to the input unit 206b.

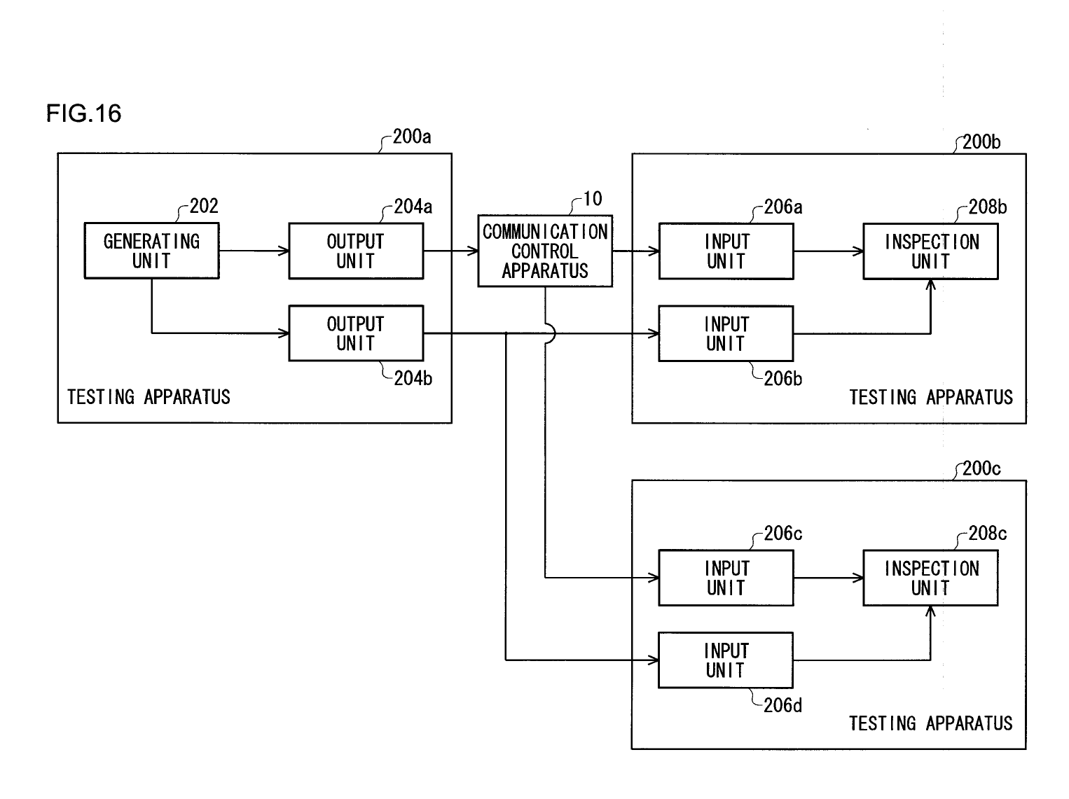

FIG. 16 shows yet another illustrative configuration of the testing apparatus according to the embodiment. In the example shown in FIG. 16, the communication control apparatus 10 outputs two series of data. For example, there may be a case where in the communication control apparatus 10 for performing packet filtering are provided a system for outputting a packet to be passed and a system for outputting an error message or the like with respect to a packet to be blocked. In this case, testing apparatuses 200b and 200c are provided for the two series of data output by the communication control apparatus 10, respectively. The output unit 204b of the testing apparatus 200a outputs two series of answer data to the testing apparatuses 200b and 200c, respectively. The input unit 206a of the testing apparatus 200b inputs one series of result data output by the communication control apparatus 10, while the input unit 206b inputs answer data of the series. On the other hand, the input unit 206c of the testing apparatus 200c inputs the other series of result data output by the communication control apparatus 10, while the input unit 206d inputs answer data of the series. In the case where the communication control apparatus 10 outputs three or more series of data, sufficient number of testing apparatuses 200 may be provided accordingly.

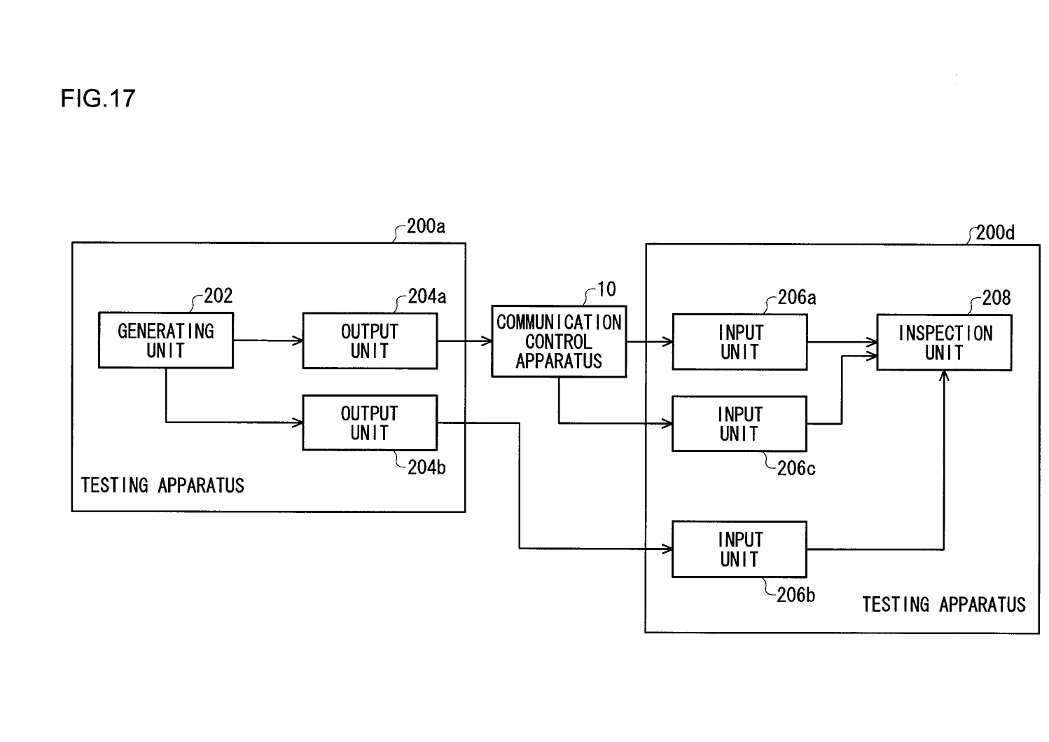

FIG. 17 shows still yet another illustrative configuration of the testing apparatus according to the embodiment. Although the testing apparatuses 200b and 200c are independently provided in the example shown in FIG. 16, a single testing apparatus 200d checks two series of data output by the communication control apparatus 10 in the example of FIG. 17. The testing apparatus 200d comprises input units 206a and 206c for inputting two series of data output by the communication control apparatus 10, respectively, and further includes an input unit 206b for inputting two series of answer data output by the output unit 204b of the testing apparatus 200a. The inspection unit 208 may comprise two comparison circuits 220 for comparing two series of result data with two series of answer data, respectively, or may compare such two series of result data and answer data using a single comparison circuit 220 in a time-sharing manner.

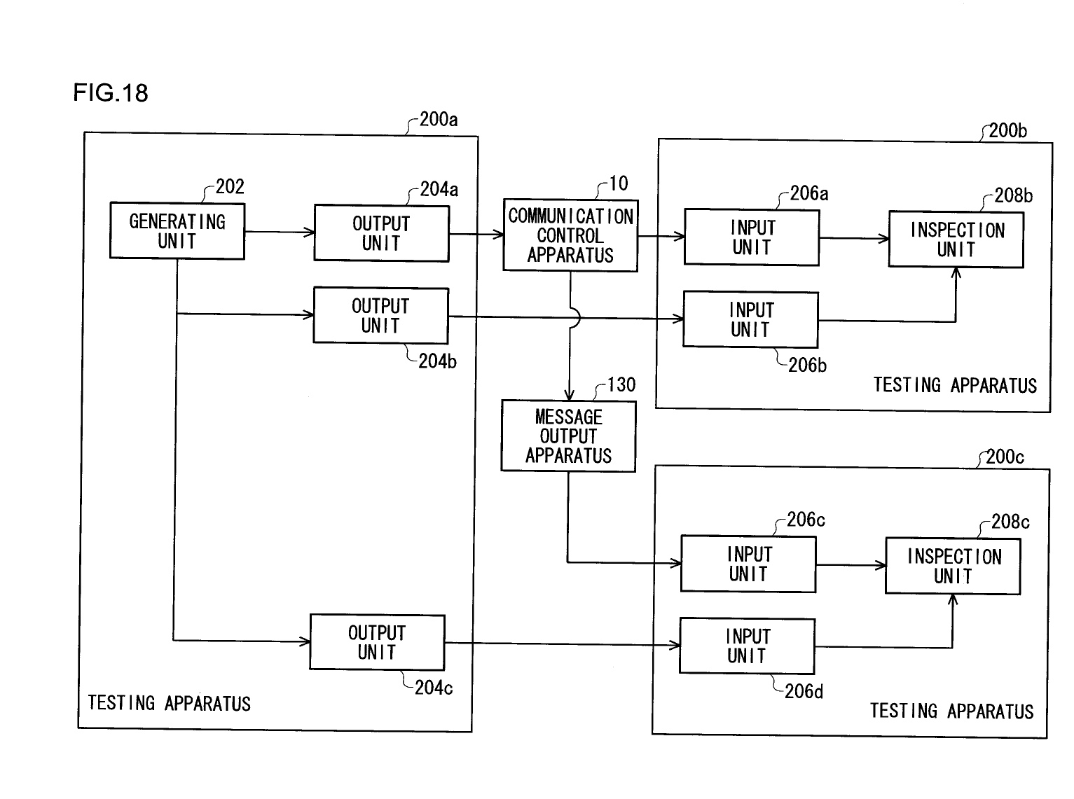

FIG. 18 shows a further illustrative configuration of the testing apparatus according to the embodiment. In the example of FIG. 18, the testing apparatus 200c is provided to test the message output apparatus 130, which outputs a message or the like according to a signal output by the communication control apparatus 10. In this case, the generating unit 202 of the testing apparatus 200a further generates answer data that should be output by the message output apparatus 130 in response to data output to the communication control apparatus 10, and the output unit 204c outputs the answer data thus generated to the testing apparatus 200c. In the testing apparatus 200c, the input unit 206c inputs result data output by the message output apparatus 130, while the input unit 206d inputs answer data output by the output unit 204c. The inspection unit 208c compares result data input by the input unit 206c with answer data input by the input unit 206d, so as to check if the message output apparatus 130 operates normally. This enables simultaneous testing of the entire communication control system 100 including peripheral apparatuses of the communication control apparatus 10, instead of only testing the communication control apparatus 10.

The present invention has been described with reference to the embodiment. The embodiment is intended to be illustrative only, and it will be obvious to those skilled in the art that various modifications to constituting elements or processes could be developed and that such modifications also fall within the scope of the present invention.

### INDUSTRIAL APPLICABILITY

The present invention is applicable to a testing apparatus for testing a communication control apparatus.

1. (canceled)

2. A testing apparatus for testing a communication control apparatus, the communication control apparatus comprising:
a first memory unit which stores reference data to be referred to when a content of processing to be performed on data is determined;
a search unit which searches input data for the reference data by comparing the data with the reference data;
a second memory unit which stores a search result obtained by the search unit and the content of processing related to each other; and
a processing unit which, on the basis of the search result, performs processing related to the search result on the data and outputs the processed data,
the testing apparatus comprising:
a first output unit which outputs data to the communication control apparatus;
a second output unit which outputs data to be output by the processing unit after the processing unit normally processes data output to the communication control apparatus;
a first input unit which inputs data output by the communication control apparatus;
a second input unit which inputs data output by the second output unit; and
an inspection unit which compares data input by the first input unit with data input by the second input unit to check if the communication control apparatus operates normally, wherein
the inspection unit estimates the processing time of the communication control apparatus by measuring the difference between the time at which the first input unit inputs data and the time at which the second input unit inputs corresponding data.

3. The testing apparatus of claim 2, wherein the communication capacity of the communication path from the first output unit via the communication control apparatus to the first input unit and the communication capacity of the communication path from the second output unit to the second input unit are equalized.

4. The testing apparatus of claim 2, wherein the communication control apparatus outputs a plurality of series of data, and the testing apparatuses are provided for each series of data output from the communication control apparatus.

5. The testing apparatus of claim 2, further comprising:
a third output unit which outputs data to be output by a message output apparatus which outputs a message according to a signal output by the communication control apparatus after the message output apparatus normally processes data output to the communication control apparatus;
a third input unit which inputs data output by the message output apparatus; and
a fourth input unit which inputs data output by the third output unit, wherein
the inspection unit compares data input by the third input unit with data input by the fourth input unit to check if the message output apparatus operates normally.

6. (canceled)

7. A computer program product embedded in a computer readable recording medium, for testing a communication control apparatus, the communication control apparatus comprising:
a first memory unit which stores reference data to be referred to when a content of processing to be performed on data is determined;
a search unit which searches input data for the reference data by comparing the data with the reference data;
a second memory unit which stores a search result obtained by the search unit and the content of processing related to each other; and
a processing unit which, on the basis of the search result, performs processing related to the search result on the data and outputs the processed data,
the program product comprising:
a first output module for outputting data to the communication control apparatus;
a second output module for outputting data to be output by the processing unit after the processing unit normally processes data output to the communication control apparatus;
a first input module for inputting data output by the communication control apparatus;
a second input module for inputting data output by the second output module; and
an inspection module for comparing data input by the first input module with data input by the second input module to check if the communication control apparatus operates normally, wherein
the inspection module estimates the processing time of the communication control apparatus by measuring the difference between the time at which the first input module inputs data and the time at which the second input module inputs corresponding data.

8. The computer program product of claim 7, further comprising:
a third output module which outputs data to be output by a message output apparatus which outputs a message according to a signal output by the communication control apparatus after the message output apparatus normally processes data output to the communication control apparatus;
a third input module which inputs data output by the message output apparatus; and
a fourth input module which inputs data output by the third output module, wherein
the inspection module compares data input by the third input module with data input by the fourth input module to check if the message output apparatus operates normally.
